(19) United States
(12) Patent Application Publication
(10) Pub. No.: US 2010/0008816 A1
(43) Pub. Date: Jan. 14, 2010

(54) NICKEL-BASED SUPERALLOYS, REPAIRED TURBINE ENGINE COMPONENTS, AND METHODS FOR REPAIRING TURBINE COMPONENTS

(75) Inventor: Yiping Hu, Greer, SC (US)

Correspondence Address: HONEYWELL/IFL;Patent Services, 101 Columbia Road, P.O.Box 2245, Morristown, NJ, 07962-2245, US

(73) Assignee: Honeywell International Inc., Morristown, NJ (US)

(21) Appl. No.: 12/171,538

(22) Filed: Jul. 11, 2008

(51) Int. Cl. C22C 19/05; B23P 6/00; B23K 26/20

(52) U.S. Cl. 420/445; 29/888.021; 219/121.64

(57) ABSTRACT

Nickel-based superalloys, repaired turbine components, and methods repairing turbine components are provided. In an embodiment, by way of example only, a nickel-based superalloy consists essentially of, by weight percent, chromium in a range of from about 7.0 percent to about 8.0 percent, cobalt in a range of from about 5.5 percent to about 6.5 percent, tungsten in a range of from about 3.0 percent to about 4.0 percent, rhenium in a range of from about 2.2 percent to about 2.8 percent, aluminum in a range of from about 7.5 percent to about 8.5 percent, tantalum in a range of from about 5.5 percent to about 6.5 percent, silicon in a range of from about 0.2 percent to about 0.5 percent, hafnium in a range of from about 0.15 percent to about 0.25 percent, and a balance of nickel.

### TECHNICAL FIELD

The inventive subject matter generally relates to turbine engine components and more particularly relates to nickel-based superalloys and methods for repairing the components.

### BACKGROUND

Turbine engines are used as the primary power source for various kinds of aircrafts. The engines may also serve as auxiliary power sources that drive air compressors, hydraulic pumps, and industrial electrical power generators. Most turbine engines generally follow the same basic power generation procedure. Compressed air is mixed with fuel and burned, and the expanding hot combustion gases are directed against stationary turbine vanes in the engine. The vanes turn the high velocity gas flow partially sideways to impinge onto turbine blades mounted on a rotatable turbine disk. The force of the impinging gas causes the turbine disk to spin at high speed. Jet propulsion engines use the power created by the rotating turbine disk to draw more air into the engine, and the high velocity combustion gas is passed out of the gas turbine aft end to create forward thrust. Turbine engines are also used to drive one or more propellers, electrical generators, or other devices.

Turbine engine blades and vanes are fabricated from high temperature materials such as a nickel-based and/or cobalt-based superalloy. Although nickel-based and cobalt-based superalloys have good high temperature properties and many other advantages, they are susceptible to corrosion, oxidation, thermal fatigue and erosion damage in the harsh environment of an operating turbine engine. These limitations are problematic as there is a constant drive to increase engine operating temperatures in order to increase fuel efficiency and to reduce emission. Replacing damaged turbine engine components made from advanced nickel-based superalloys is expensive, and significant research is undergone to find cost-effective ways to repair these components.

Hence, there is a need for methods and materials for repairing turbine engine components such as the turbine blades and vanes. There is a particular need for environment-resistant repair materials that will improve a turbine component's durability, and for efficient and cost effective methods of repairing the components using such materials. Furthermore, other desirable features and characteristics of the inventive subject matter will become apparent from the subsequent detailed description of the inventive subject matter and the appended claims, taken in conjunction with the accompanying drawings and this background of the inventive subject matter.

### BRIEF SUMMARY

Nickel-based superalloys, repaired turbine components, and methods for repairing turbine components are provided.

In an embodiment, by way of example only, a nickel-based superalloy includes, in weight percent, chromium in a range of from about 7.0 percent to about 8.0 percent, cobalt in a range of from about 5.5 percent to about 6.5 percent, tungsten in a range of from about 3.0 percent to about 4.0 percent, rhenium in a range of from about 2.2 percent to about 2.8 percent, aluminum in a range of from about 7.5 percent to about 8.5 percent, tantalum in a range of from about 5.5 percent to about 6.5 percent, silicon in a range of from about 0.2 percent to about 0.5 percent, hafnium in a range of from about 0.15 percent to about 0.25 percent, and a balance of nickel.

In another embodiment, by way of example only, a repaired turbine component includes an airfoil comprising a first nickel-based superalloy and a restored portion on the airfoil. The restored portion comprises a second nickel-based superalloy including, in weight percent, chromium in a range of from about 7.0 percent to about 8.0 percent, cobalt in a range of from about 5.5 percent to about 6.5 percent, tungsten in a range of from about 3.0 percent to about 4.0 percent, rhenium in a range of from about 2.2 percent to about 2.8 percent, aluminum in a range of from about 7.5 percent to about 8.5 percent, tantalum in a range of from about 5.5 percent to about 6.5 percent, silicon in a range of from about 0.2 percent to about 0.5 percent, hafnium in a range of from about 0.15 percent to about 0.25 percent, and a balance of nickel.

In yet another embodiment, by way of example only, a method of repairing a turbine component includes providing a turbine engine component having a damaged area; and applying a nickel-based superalloy onto the damaged area to form a restored portion, the nickel-based superalloy including, in weight percent, about 7.5 percent chromium, about 6.0 percent cobalt, about 3.5 percent tungsten, about 2.4 percent rhenium, about 8.0 percent aluminum, about 6.0 percent tantalum, about 0.4 percent silicon, about 0.2 percent hafnium, and a balance of nickel.

### BRIEF DESCRIPTION OF THE DRAWINGS

The inventive subject matter will hereinafter be described in conjunction with the following drawing figures, wherein like numerals denote like elements, and

FIG. 1 is a perspective view of a repaired turbine engine component, according to an embodiment;

FIG. 2 is a cross-sectional view of a portion of a repaired turbine engine component, according to an embodiment;

FIG. 3 is a cross-sectional view of a protective coating system that may be included over a turbine engine component, according to an embodiment; and

FIG. 4 is flow diagram of a method of repairing a turbine engine component, according to an embodiment.

### DETAILED DESCRIPTION

The following detailed description is merely exemplary in nature and is not intended to limit the inventive subject matter or the application and uses of the inventive subject matter. Furthermore, there is no intention to be bound by any theory presented in the preceding background or the following detailed description.

An improved, nickel-based superalloy composition is provided that may have superior elevated-temperature properties over those of conventional superalloys. In an embodiment, the inclusion of certain elements, such as aluminum, silicon, and chromium, improves oxidation-resistance when the improved, nickel-based superalloy is exposed to engine operating temperatures, such as turbine inlet temperatures greater than about 2200° F. (1205° C.). In an example, the improved, nickel-based superalloy composition may improve resistance to erosion or materials loss due to corrosion, oxidation, thermal fatigue, and other hazards when used for the repair of high pressure turbine (HPT) components such as turbine blades and vanes.

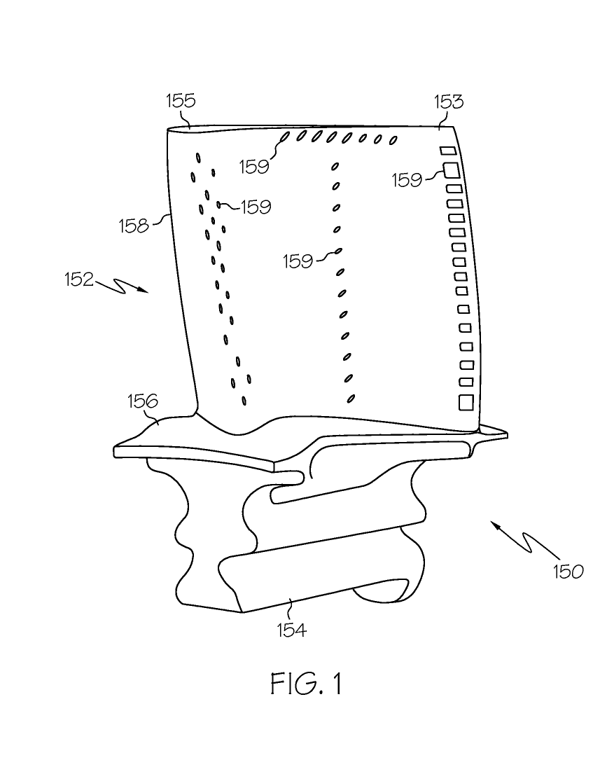

FIG. 1 is a perspective view of a repaired turbine engine component 150, according to an embodiment. Here, the repaired turbine engine component 150 is shown as a turbine blade. However, in other embodiments, the repaired turbine engine component 150 may be a turbine vane or other component that may be implemented in a gas turbine engine, or other high-temperature system. In an embodiment, the repaired turbine engine component 150 may include an airfoil 152 that includes a pressure side surface 153, an attachment portion 154, a leading edge 158 including a blade tip 155, and/or a platform 156. In accordance with an embodiment, the repaired turbine engine component 150 may be formed with a non-illustrated outer shroud attached to the tip 155. The repaired turbine engine component 150 may have non-illustrated internal air-cooling passages that remove heat from the turbine airfoil. After the internal air has absorbed heat from the blade, the air is discharged into a hot gas flow path through passages 159 in the airfoil wall. Although the repaired turbine engine component 150 is illustrated as including certain parts and having a particular shape and dimension, different shapes, dimensions and sizes may be alternatively employed depending on particular gas turbine engine models and particular applications.

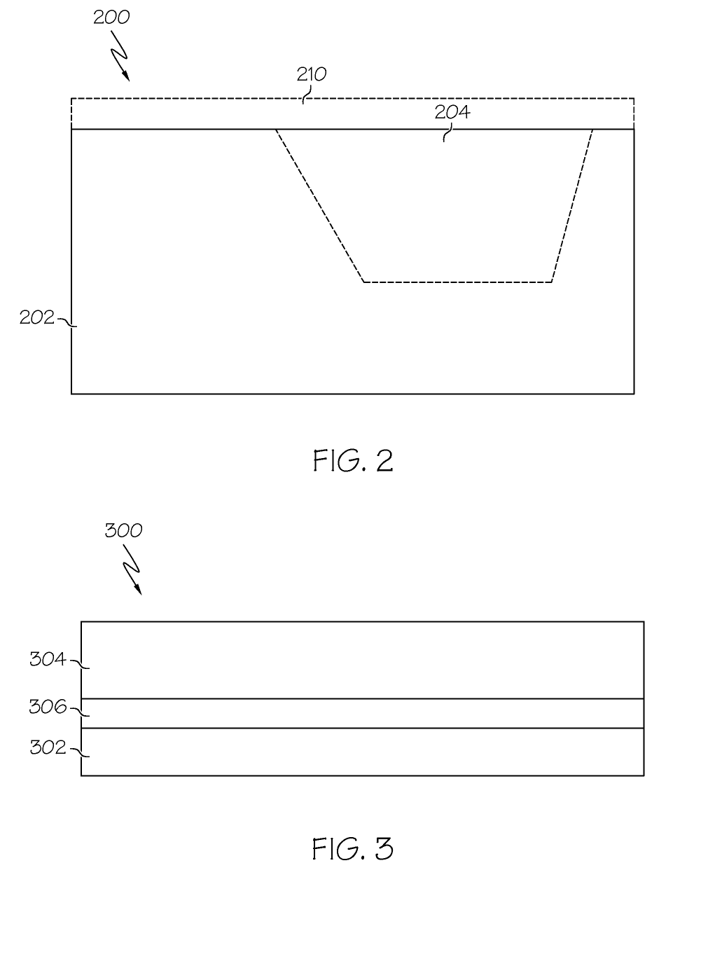

FIG. 2 is a cross-sectional view of a portion of a repaired turbine engine component 200, according to an embodiment. The portion may be included on one or more of a leading edge, trailing edge, or tip of a blade, in an embodiment. In another embodiment in which the blade is implemented in a knife seal, the portion may be included as an edge of the blade defining the knife seal. In any case, the repaired turbine engine component 200 may include a base material 202 and a restored portion 204 over at least a portion thereof. Though a dotted line is shown between the base material 202 and the restored portion 204, it will be appreciated that in an embodiment, the two may be seamless and metallurgical bonding or a metallurgical interface therebetween may be produced during welding repair. In some embodiments, as shown in phantom, a protective coating system 210 may be deposited over the turbine engine component 200.

In an embodiment, the base material 202 comprises a first nickel-based superalloy. For example, the first nickel-based superalloy may be selected from a high performance nickel-based superalloy, including, but not limited to IN738, IN792, C101, MarM247, Rene80, Rene125, ReneN5, SC180, CMSX 4, and PWA1484. In other embodiments, the base material 202 may comprise a cobalt-based superalloy or another superalloy conventionally employed for the fabrication of turbine engine components.

The restored portion 204 includes a second nickel-based superalloy having a composition that is different than the composition of the first nickel-based superalloy. In an embodiment, the second nickel-based superalloy has oxidation-resistance properties that are greatly improved over those of the first nickel-based superalloy and includes elements selected from cobalt, chromium, aluminum, tantalum, tungsten, rhenium, hafnium, silicon, carbon, boron, yttrium, and lanthanum. In one embodiment, the composition of the second nickel-based superalloy may include, in weight percent, chromium in a range of from about 7.0 percent to about 8.0 percent, cobalt in a range of from about 5.5 percent to about 6.5 percent, tungsten in a range of from about 3.0 percent to about 4.0 percent, rhenium in a range of from about 2.2 percent to about 2.8 percent, aluminum in a range of from about 7.5 percent to about 8.5 percent, tantalum in a range of from about 5.5 percent to about 6.5 percent, silicon in a range of from about 0.2 percent to about 0.5 percent, hafnium in a range of from about 0.15 percent to about 0.25 percent, and a balance of nickel. For example, in a preferred embodiment, the composition of the second nickel-based superalloy may include, in weight percent, about 7.5 percent chromium, about 6.0 percent cobalt, about 3.5 percent tungsten, about 2.4 percent rhenium, about 8.0 percent aluminum, about 6.0 percent tantalum, about 0.4 percent silicon, about 0.2 percent hafnium, and a balance of nickel. In accordance with another embodiment, the composition of the second nickel-based superalloy may further include, in weight percent, from about 0.001 to about 0.015 weight percent of a material selected from the group consisting of yttrium, lanthanum, and a combination thereof. In still another embodiment, the composition of the second nickel-based superalloy may still further include, in weight percent, from about 0.02 to about 0.06 percent carbon and from about 0.008 to about 0.012 percent boron.

By including aluminum, chromium, and silicon in the composition of the second nickel-based superalloy, oxidation resistance properties of the alloy may be improved over conventional nickel-based superalloys. It has been found that aluminum, chromium, and silicon may react with oxygen to form an oxide layer over the second nickel-based superalloy that protects against oxidation. In order to prevent the oxide layer from becoming undesirably thick, hafnium is included at a ratio relative to the silicon, where the ratio is in a range of between about 0.3 to about 0.7. At such amounts, hafnium diffuses into grain boundaries of oxides within the second nickel-based superalloy to decrease a rate at which an oxide scale grows so that the oxide layer remains relatively thin As a result, spallation of the oxide layer may be minimized, and the presence of the oxide layer may provide additional oxidation resistance for the alloy. Yttrium, lanthanum, and/or other reactive elements may be included in the composition of the second nickel-based superalloy to tie up the sulfur that may be present when the turbine engine component 200 is made from nickel-based superalloy or exposed to operating gases or when a platinum aluminide coating is formed thereover. Specifically, yttrium, lanthanum, and/or other reactive elements may react with sulfur to form stable sulfides to prevent the sulfur from diffusing to the surface of the superalloy. This may also improve the adherence of protective thin layer alumina scale to the alloy.

To further protect the turbine engine component 200 which may be exposed to the harsh operating temperatures, the protective coating system 210 may be included, in an embodiment. FIG. 3 is a cross-sectional view of a protective coating system 300 that may be included over a turbine engine component, according to an embodiment. The protective coating system 300 may include a bond coating 302, a thermal barrier coating 304, and one or more intermediate layers therebetween, such as a thermally grown oxide (TGO) 306. In one embodiment, the bond coating 302 may be a diffusion aluminide coating. For example, the diffusion aluminide coating may be formed by depositing an aluminum layer over the base material 202 (FIG. 2) and/or the restored portion 204 (FIG. 2), and subsequently interdiffusing the aluminum layer therewith the substrate to form aluminide coating. According to one embodiment, the diffusion aluminide coating is a simple diffusion aluminide, including a single layer made up of aluminum interacting with the base material 202 and/or the restored portion 204. In another embodiment, the diffusion aluminide coating may have a more complex structure and may include one or more additional metallic layers that are diffused into the aluminum layer, the base material 202, and/or the restored portion 204. For example, an additional metallic layer may include a platinum layer, a hafnium and/or a zirconium layer, or a co-deposited hafnium, zirconium, and platinum layer.

In another embodiment, the bond coating 302 may be an overlay coating comprising MCrAlX, wherein M is an element selected from cobalt, nickel, or combinations thereof, and X is an element selected from hafnium, zirconium, yttrium, tantalum, rhenium, ruthenium, palladium, platinum, silicon, or combinations thereof. Some examples of MCrAlX compositions include NiCoCrAlY and CoNiCrAlY. In another exemplary embodiment, the bond coating 302 may include a combination of two types of bond coatings, such as a diffusion aluminide coating formed on an MCrAlX coating. In any case, the bond coating 302 may have a thickness in a range of from about 25 microns (μm) to about 150 μm, according to an embodiment. In other embodiments, the thickness of the bond coating 302 may be greater or less.

The thermal barrier coating 304 may be formed over the bond coating 302 and may comprise, for example, a ceramic. In one example, the thermal barrier coating 304 may comprise a partially stabilized zirconia-based thermal barrier coating, such as yttria stabilized zirconia (YSZ). In an embodiment, the thermal barrier coating may comprise yttria stabilized zirconia doped with other oxides, such as Gd₂O₃, TiO₂, and the like. In another embodiment, the thermal barrier coating 304 may have a thickness that may vary and may be, for example, in a range from about 50 μm to about 300 μm. In other embodiments, the thickness of the thermal barrier coating 304 may be in a range of from about 100 μm to about 250 μm. In still other embodiments, the thermal barrier coating 304 may be thicker or thinner than the aforementioned ranges.

The thermally-grown oxide layer 306 may be located between the bond coating 302 and the thermal barrier coating 304. In an embodiment, the thermally-grown oxide layer 306 may be grown from aluminum in the above-mentioned materials that form the bond coating 302. For example, after a heat treatment during bond coating 302 deposit, oxidation may occur thereon to result in the formation of the oxide layer 306. In one embodiment, the thermally-grown oxide layer 306 may be relatively thin, and may be less than 2 μm thick.

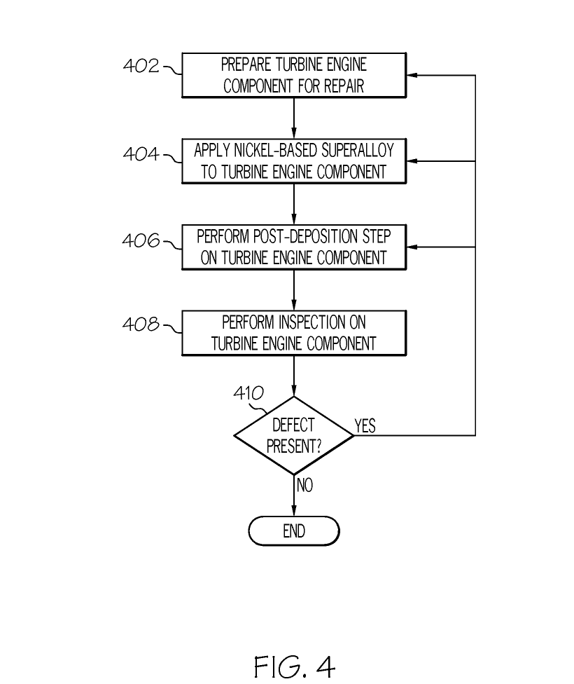

To repair a degraded turbine engine component, a method 400, depicted in a flow diagram provided in FIG. 4, may be employed. Although the following method 400 is described with reference to repair of a turbine blade, it should be understood that the method 400 is not limited to blades or any other particular components. According to an embodiment, the turbine engine component is prepared for repair, step 402. In an embodiment, the turbine engine component may be prepared by identifying one or more worn or damaged turbine engine components, such as damaged turbine blades, on a turbine rotor, and detaching the worn or damaged turbine engine components from the turbine rotor. In an embodiment, step 402 may include chemically preparing the surface of the turbine engine component at least in proximity to and/or on surfaces defining the structural feature. For example, in an embodiment in which the turbine engine component includes an outer environment-protection coating, the coating may be removed. Thus, a chemical stripping solution may be applied to a surface of the turbine engine component, such as the surfaces and portions of the component surrounding and/or defining the structural feature. Suitable chemicals used to strip the coating may include, for example, nitric acid solution. However, other chemicals may alternatively be used, depending on a particular composition of the coating.

In another embodiment of step 402, the turbine engine component may be mechanically prepared. Examples of mechanical preparation include, for example, pre-repair machining and/or degreasing surfaces in proximity to and/or defining the structural feature in order to remove any oxidation, dirt or other contaminants. In another embodiment, additional or different types and numbers of preparatory steps can be performed. It will be appreciated that the present embodiment is not limited to these preparatory steps, and that additional, or different types and numbers of preparatory steps can be conducted.

Once the turbine engine component has been prepared, a nickel-based superalloy may be applied thereto, step 404. In an embodiment, the nickel-based superalloy may be laser-welded onto the worn or damaged area. In an example, the nickel-based superalloy may comprise any one of the above-described superalloy compositions used for a restored portion (e.g., restored portion 204 in FIG. 2) of a turbine blade. The nickel-based superalloy may be provided as substantially spherical powder particles, which provide improved powder flow property and may help maintain a stable powder feed rate during the welding process. The nickel-based superalloy powder may be used in conjunction with a CO₂ laser, a YAG laser, a diode laser, or a fiber laser. In an embodiment, a welding process includes laser powder fusion welding, in which the nickel-based superalloy is laser deposited onto a degraded area to restore both geometry and dimension with metallurgically sound buildup. Both automatic and manual laser welding systems are widely used to perform laser powder fusion welding processes. An exemplary manual welding repair is described in detail in U.S. Pat. No. 6,593,540 entitled “Hand Held Powder-Fed Laser Fusion Welding Torch” and incorporated herein by reference.

In another embodiment, applying the nickel-based superalloy to the worn or damaged area may include plasma transfer arc (PTA), micro plasma, and tungsten inert gas (TIG) welding methods. In still other embodiments, the step of applying the nickel-based superalloy may include performing a thermal spray process such as high velocity oxygen fuel (HVOF) thermal spraying or performing low pressure plasma spraying (LPPS) methods.

In still yet another embodiment, applying the nickel-based superalloy may include performing a cold gas-dynamic spraying. In this process, a cold spray system mixes particles of the nickel-based superalloy with a suitable pressurized gas in a mixing chamber. The particles are then accelerated through the specially designed nozzle and directed toward a target surface on the turbine engine component. When the particles strike the target surface, the kinetic energy of the particles is converted into plastic deformation of the particle, causing the particle to form a strong bond with the target surface and produce a coating. In this method, the particles are applied and deposited in the solid state, i.e., at a temperature which is considerably lower than the melting point of the powder material.

Returning to the flow diagram of FIG. 4, after the application step 404 is completed, at least one post-deposition step is performed on the turbine engine component, step 406. A particular post-deposition step may depend on the type of application process that was performed in step 404. For example, if a spraying process was performed to repair the turbine blade, then one exemplary post-deposition step is a hot isostatic pressing (HIP) process performed for about four hours at 2200° F. (about 1205° C.) with an applied pressure of 15 ksi. In another embodiment, the post-deposition step 406 can further include additional processes that improve the mechanical properties and metallurgical integrity of the turbine engine component. Such processes may include final machining the repaired turbine engine component to a predetermined or original design dimension. Other processes include re-coating the repaired turbine engine component with a suitable coating material such as environment-resistant diffusion aluminide and/or MCrAlY overlay coatings, coating diffusion, and aging heat treatments to homogenize microstructures and improve performance of the repaired turbine airfoils.

After the post-deposition step 406 is completed, at least one inspection process can be performed, step 408. In an embodiment, the inspection process may be employed to determine whether any surface defects exist, such as cracks or other openings, step 410. The inspection process may be conducted using any well-known non-destructive inspection techniques including, but not limited to, a fluorescent penetration inspection, and a radiographic inspection. If an inspection process indicates that a surface defect exists, the turbine blade is subjected to an additional repair process, and the process may return to either steps 402, 404, or 406. If an inspection process indicates that a surface defect does not exist, the process ends and the repaired turbine engine component may be ready to be implemented into a turbine engine or other system.

A novel nickel-based superalloy and an improved method for repairing turbine engine components have now been provided. The novel nickel-based superalloy may provide improved oxidation-resistance over conventional nickel-based superalloys when subjected to engine operating temperatures. Additionally, the repair methods in which the novel nickel-based superalloys are used may be employed not only on blades, but also on other turbine components, including, but not limited to, vanes and shrouds. The repair method may also improve the durability of the turbine component, thereby optimizing the operating efficiency of a turbine engine, and prolonging the operational life of turbine blades and other engine components.

While at least one exemplary embodiment has been presented in the foregoing detailed description of the inventive subject matter, it should be appreciated that a vast number of variations exist. It should also be appreciated that the exemplary embodiment or exemplary embodiments are only examples, and are not intended to limit the scope, applicability, or configuration of the inventive subject matter in any way. Rather, the foregoing detailed description will provide those skilled in the art with a convenient road map for implementing an exemplary embodiment of the inventive subject matter. It being understood that various changes may be made in the function and arrangement of elements described in an exemplary embodiment without departing from the scope of the inventive subject matter as set forth in the appended claims.

1. A nickel-based superalloy consisting essentially of, in weight percent:
chromium in a range of from about 7.0 percent to about 8.0 percent;
cobalt in a range of from about 5.5 percent to about 6.5 percent;
tungsten in a range of from about 3.0 percent to about 4.0 percent;
rhenium in a range of from about 2.2 percent to about 2.8 percent;
aluminum in a range of from about 7.5 percent to about 8.5 percent;
tantalum in a range of from about 5.5 percent to about 6.5 percent;
silicon in a range of from about 0.2 percent to about 0.5 percent;
hafnium in a range of from about 0.15 percent to about 0.25 percent; and
a balance of nickel.

2. The nickel-based superalloy of claim 1, further consisting essentially of about 0.02 to about 0.06 percent by weight of carbon and about 0.008 to about 0.012 percent by weight of boron.

3. The nickel-based superalloy of claim 2, further consisting essentially of about 0.04 percent by weight of carbon and about 0.01 percent by weight of boron.

4. The nickel-based superalloy of claim 3, further consisting essentially of from about 0.001 to about 0.015 weight percent of lanthanum.

5. The nickel-based superalloy of claim 1, wherein a ratio between hafnium and silicon is in a range from about 0.3 to about 0.7.

6. The nickel-based superalloy of claim 1, further consisting essentially of, by weight percent:
about 7.5 percent chromium;
about 6.0 percent cobalt;
about 3.5 percent tungsten;
about 2.4 percent rhenium;
about 8.0 percent aluminum;
about 6.0 percent tantalum;
about 0.4 percent silicon; and
about 0.2 percent hafnium.

7. A repaired turbine engine component comprising:
an airfoil comprising a first nickel-based superalloy; and
a restored portion on the airfoil, the restored portion comprising a second nickel-based superalloy including, by weight percent:
chromium in a range of from about 7.0 percent to about 8.0 percent;
cobalt in a range of from about 5.5 percent to about 6.5 percent;
tungsten in a range of from about 3.0 percent to about 4.0 percent;
rhenium in a range of from about 2.2 percent to about 2.8 percent;
aluminum in a range of from about 7.5 percent to about 8.5 percent;
tantalum in a range of from about 5.5 percent to about 6.5 percent;
silicon in a range of from about 0.2 percent to about 0.5 percent;
hafnium in a range of from about 0.15 percent to about 0.25 percent; and
a balance of nickel.

8. The repaired turbine engine component of claim 7, wherein the second nickel-based superalloy further consists essentially of about 0.04 percent by weight of carbon, about 0.01 percent by weight of boron, and from about 0.001 to about 0.015 weight percent of a material selected from a group consisting of yttrium, lanthanum, and a combination thereof.

9. The repaired turbine engine component of claim 7, wherein the second nickel-based superalloy further consists essentially of, by weight percent:
about 7.5 percent chromium;
about 6.0 percent cobalt;
about 3.5 percent tungsten;
about 2.4 percent rhenium;
about 8.0 percent aluminum;
about 6.0 percent tantalum;
about 0.4 percent silicon; and
about 0.2 percent hafnium.

10. The repaired turbine engine component of claim 7, wherein the airfoil comprises a leading edge and the restored portion is deposited on the leading edge.

11. The repaired turbine engine component of claim 7, wherein the airfoil comprises a trailing edge and the restored portion is deposited on the trailing edge.

12. The repaired turbine engine component of claim 7, wherein the airfoil comprises a tip and the restored portion is deposited on the tip.

13. A method of repairing a turbine engine component, the method comprising the steps of:
providing a turbine engine component having a damaged area; and
applying a nickel-based superalloy onto the damaged area to form a restored portion, the nickel-based superalloy including by weight percent about 7.5 percent chromium, about 6.0 percent cobalt, about 3.5 percent tungsten, about 2.4 percent rhenium, about 8.0 percent aluminum, about 6.0 percent tantalum, about 0.4 percent silicon, about 0.2 percent hafnium, and a balance of nickel.

14. The method of claim 13, wherein the nickel-based superalloy further comprises about 0.04 percent by weight of carbon and about 0.01 percent by weight of boron.

15. The method of claim 14, wherein the nickel-based superalloy further comprises from about 0.001 to about 0.015 weight percent of a material selected from a group consisting of yttrium, lanthanum, and a combination thereof.

16. The method of claim 13, wherein the nickel-based superalloy further comprises, by weight percent, about 7.5 percent chromium, about 6.0 percent cobalt, about 3.5 percent tungsten, about 2.4 percent rhenium, about 8.0 percent aluminum, about 6.0 percent tantalum, about 0.4 percent silicon, and about 0.2 percent hafnium.

17. The method of claim 13, wherein the step of applying further comprises laser-welding the nickel-based superalloy to the damaged area.

18. The method of claim 13, further comprising the step of:
subjecting the turbine engine component to a hot isostatic pressing process after applying the nickel-based superalloy to the damaged area.

19. The method of claim 13, further comprising the step of:
heat treating the turbine engine component after applying the nickel-based superalloy to the damaged area.
